(19) United States
(12) Patent Application Publication
(10) Pub. No.: US 2014/0136177 A1
(43) Pub. Date: May 15, 2014

(54) CRITICAL PATH EMULATING APPARATUS USING HYBRID ARCHITECTURE

(71) Applicant: MEDIATEK INC., Hsin-Chu (TW)

(72) Inventors: Ming-Hsien Lee, Hsinchu City (TW); Shih-Tsung Hsiao, New Taipei City (TW); Hsin-Chen Chen, Tainan City (TW)

(73) Assignee: MEDIATEK INC., Hsin-Chu (TW)

(21) Appl. No.: 13/672,723

(22) Filed: Nov. 9, 2012

(51) Int. Cl. G06F 17/50

(52) U.S. Cl. 703/14

(57) ABSTRACT

A critical path emulating apparatus includes a critical path emulator (CPE) and an interconnection circuit. The CPE is capable of emulating a critical path of a target device, and supporting a plurality of speed information detection modes. The interconnection circuit is capable of supporting a plurality of interconnection arrangements, wherein when the interconnection circuit is configured to have a first interconnection arrangement, the CPE is capable of being used in a first speed information detection mode, and when the interconnection circuit is configured to have a second interconnection arrangement, the CPE is capable of being used in a second speed information detection mode.

### BACKGROUND

The disclosed embodiments of the present invention relate to monitoring speed information of a target device, and more particularly, to a hybrid critical path emulating apparatus employed in a critical path monitor.

Semiconductor chips/dies are engineered with sufficient performance margins to ensure that they meet the target performance under worst case operating conditions (e.g., the worst process and temperature conditions). Since the semiconductor chip/die is designed to meet the most demanding application throughput requirements under worst case operating condition, it leads to an excess margin or wastage of power under typical operating conditions. Consequently, excess power is consumed for most cases when the operating conditions are more benign.

Adaptive voltage scaling (AVS) is a technology that is widely used for low power designs. For example, AVS may provide the lowest operation voltage for a given processing frequency of a processor by utilizing a closed loop approach. The AVS loop can regulate the processor performance by adjusting the supply voltage of the power supply to compensate for process and temperature variation in the processor. In other words, a feedback loop can be introduced to the power controller to indicate how fast or slow a target device (e.g., a processor or one core of a multi-core processor) is actually running. As a result, the supply voltage can be adaptively scaled to a minimum value required for the desired operating speed of the target device. Hence, an AVS margin monitor is needed to provide the speed information as a margin index for power management. How to properly design the AVS margin monitor to make the target device maintain the same performance with the lowest power consumption has become an issue to be solved in the pertinent field.

### SUMMARY

In accordance with exemplary embodiments of the present invention, a critical path emulating apparatus with a hybrid critical path emulator (CPE) capable of switching between different CPE elements and/or a hybrid interconnection circuit capable of controlling the CPE to switch between a plurality of speed information detection modes is proposed, to solve the above-mentioned problems.

According to a first aspect of the present invention, an exemplary critical path emulating apparatus is disclosed. The exemplary critical path emulating apparatus includes a critical path emulator (CPE) and an interconnection circuit. The CPE is capable of emulating a critical path of a target device, and supporting a plurality of speed information detection modes. The interconnection circuit supports a plurality of interconnection arrangements, wherein when the interconnection circuit is configured to have a first interconnection arrangement, the CPE is capable of being used in a first speed information detection mode, and when the interconnection circuit is configured to have a second interconnection arrangement, the CPE is capable of being used in a second speed information detection mode.

According to a second aspect of the present invention, an exemplary critical path emulating apparatus is disclosed. The exemplary critical path emulating apparatus includes a critical path emulator (CPE) and an interconnection circuit. The CPE is capable of emulating a critical path of a target device, and includes a first CPE element capable of emulating the critical path, a second CPE element capable of emulating the critical path, and a switching device. The first CPE element and the second CPE element have different circuit structures. The interconnection circuit is capable of selecting and coupling one of the first CPE element and the second CPE element between an input port and an output port of the CPE. The interconnection circuit is capable of enabling the CPE to be capable of being used in a predetermined speed information detection mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a generalized critical path emulating apparatus according to an embodiment of the present invention.

FIG. 2 is a diagram illustrating an exemplary implementation of a configurable delay emulator.

FIG. 3 is a diagram illustrating an exemplary implementation of a critical path cloning circuit.

FIG. 4 is a diagram illustrating an exemplary implementation of the interconnection circuit shown in FIG. 1.

FIG. 5 is a flowchart illustrating a control method of the critical path emulating apparatus shown in FIG. 1.

FIG. 6 is a block diagram illustrating a generalized critical path emulating apparatus according to another embodiment of the present invention.

FIG. 7 is a flowchart illustrating a control method of the critical path emulating apparatus shown in FIG. 6.

FIG. 8 is a block diagram illustrating a generalized critical path emulating apparatus according to yet another embodiment of the present invention.

FIG. 9 is a flowchart illustrating a control method of the critical path emulating apparatus shown in FIG. 8.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The main concept of the present invention is to employ hybrid architecture to emulate a critical path of a target device (e.g., a processor or one core of a multi-core processor) and/or measure an operating condition (e.g., speed information) of the emulated critical path. In a preferred embodiment, a low-pass-filtered margin change and a high-speed margin variation for the same path can be obtained for speed binning (which sorts higher speed semiconductor chips/dies for higher performance target) or power saving (e.g. making chip/dies working with lower workable voltage to have the lower power consumption while having similar performance level). Specifically, regarding an AVS application, the proposed hybrid architecture is capable of reducing the margin measurement mismatch error to achieve higher AVS power saving. Besides, the proposed hybrid architecture is a cost-efficient solution as a plurality of speed information detection schemes may be combined in a single AVS margin monitor. Further details are described as below.

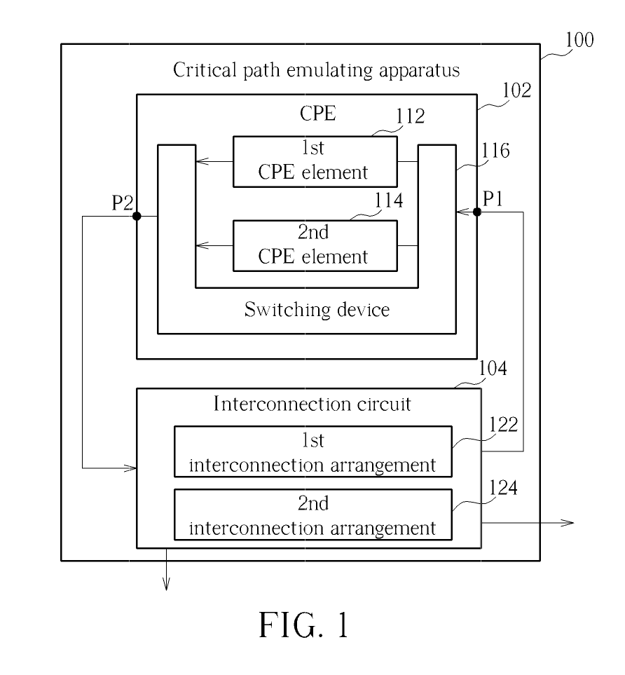

FIG. 1 is a block diagram illustrating a generalized critical path emulating apparatus according to an embodiment of the present invention. The critical path emulating apparatus 100 includes a critical path emulator (CPE) 102 and an interconnection circuit 104 coupled to the CPE 102, where each of the CPE 102 and the interconnection circuit 104 is configurable. The CPE 102 includes a plurality of CPE elements (e.g., a first CPE element 112 and a second CPE element 114) and a switching device 116 coupled to the first CPE element 112 and second CPE element 114. The interconnection circuit 104 is capable of supporting a plurality of interconnection arrangements, such as a first interconnection arrangement 122 and a second interconnection arrangement 124. It should be noted that the number of CPE elements implemented in the CPE 102 and the number of interconnection arrangements supported by the interconnection circuit 104 are for illustrative purposes only, and are not meant to be a limitation of the present invention.

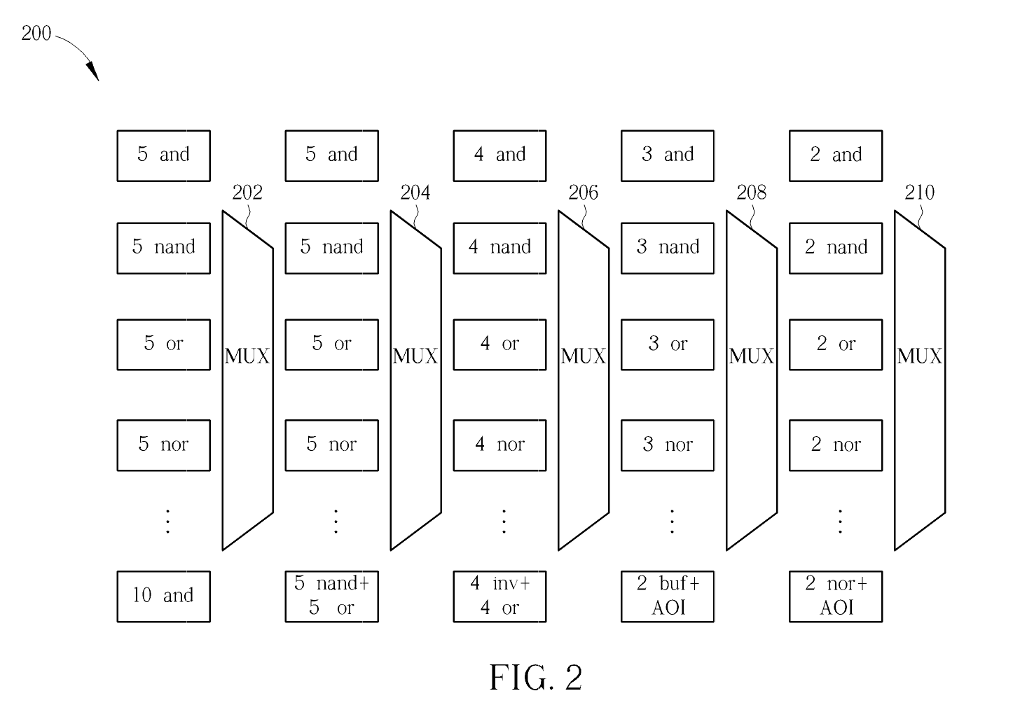

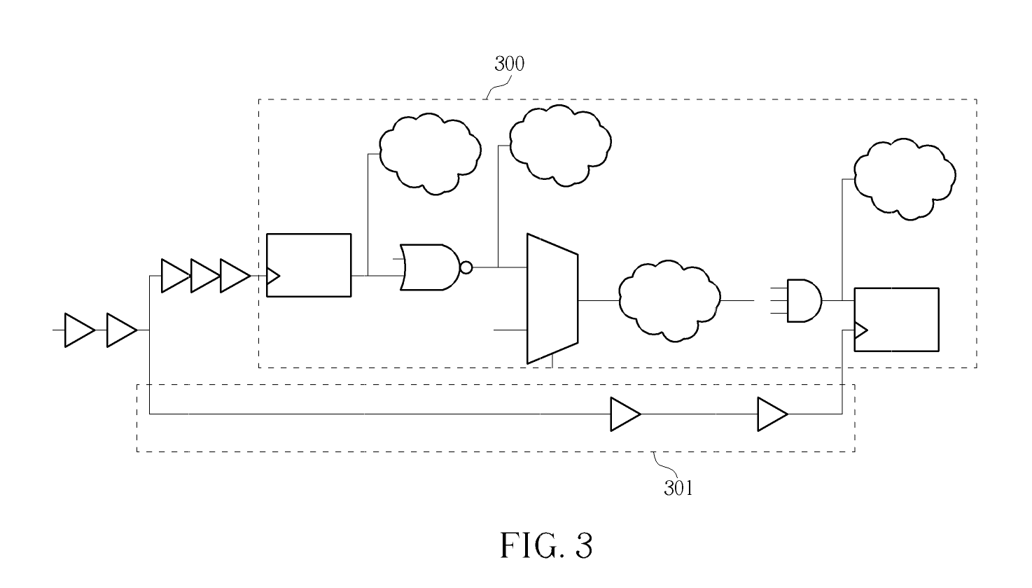

In this embodiment, the CPE 102 is capable of emulating a critical path of a target device (e.g., a processor or one core of a multi-core processor), and capable of supporting a plurality of speed information detection modes/schemes. Specifically, each of the first CPE element 112 and the second CPE element 114 in the CPE 102 is capable of emulating the critical path, where the first CPE element 112 and the second CPE element 114 may have different circuit structures. By way of example, but not limitation, the first CPE element 112 may be implemented using a configurable delay emulator (CDE), and the second CPE element 114 may be implemented using a critical path cloning (CPC) circuit. Please refer to FIG. 2 and FIG. 3. FIG. 2 is a diagram illustrating an exemplary implementation of a configurable delay emulator. FIG. 3 is a diagram illustrating an exemplary implementation of a critical path cloning circuit. As shown in FIG. 2, the configurable delay emulator 200 can have a plurality of cells (e.g., logic gates), and a cell selection of the configurable delay emulator 200 can be controlled by a plurality of multiplexers 202-210. For example, actual cells in the configurable delay emulator 200 can be selected by referring to the critical path with worst slacks as indicated in the static timing analysis (STA) report. As shown in FIG. 3, in this embodiment, the critical path cloning circuit 300 is a cloned path of the real critical path. That is, the critical path cloning circuit 300 clones the real critical path. Preferably, the location, the cloned clock tree 301, and loading of the cloned critical path would be as close as possible to the real critical path.

Regarding the switching device 116 in the CPE 102, it is capable of selecting and coupling one of the first CPE element 112 and the second CPE element 114 between an input port P1 and an output port P2 of the CPE 102. By way of example, the switching device 116 may be simply implemented using one or more multiplexers. Hence, with a proper setting of the one or more multiplexers, the CPE 102 can use one of the first CPE element 112 and the second CPE element 114 to provide an emulated critical path.

Regarding the interconnection circuit 104, it is capable of determining which one of the speed information detection modes should be enabled. That is, when the interconnection circuit 104 is configured to have the first interconnection arrangement 122, the CPE 102 is capable of being used in a first speed information detection mode, and when the interconnection circuit 104 is configured to have the second interconnection arrangement 124, the CPE 102 is capable of being used in a second speed information detection mode. For example, the first speed information detection mode may be an average mode for getting the low-pass-filtered margin change, and the second speed information mode may be a sampling mode for getting the high-speed margin variation.

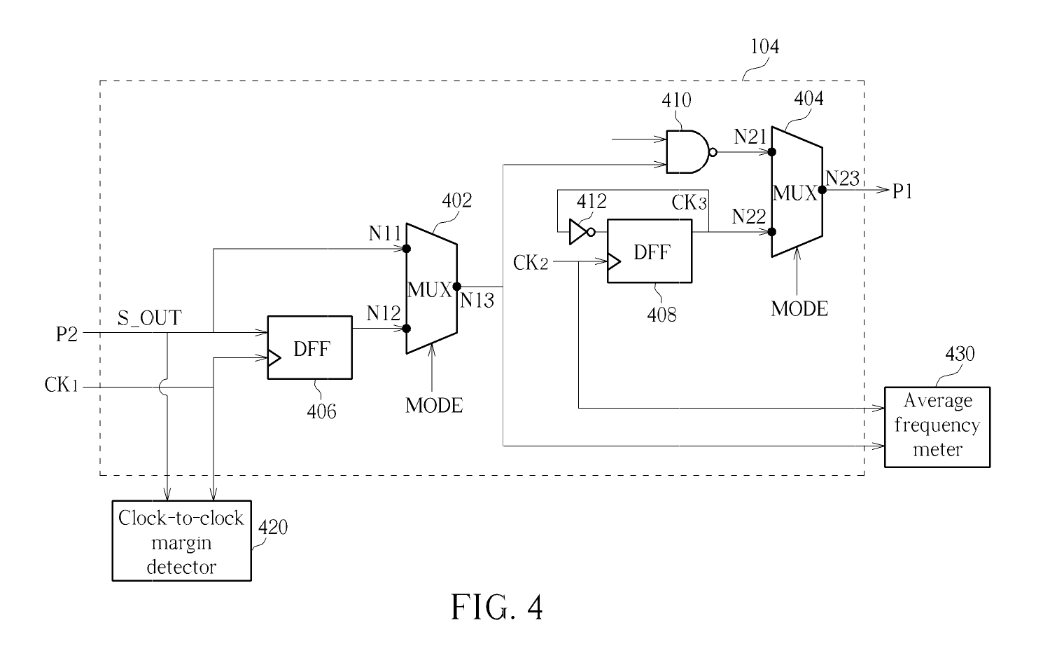

Please refer to FIG. 4, which is a diagram illustrating an exemplary implementation of the interconnection circuit 104 shown in FIG. 1. The interconnection circuit 104 may act as an average/sampling switch. In this embodiment, the interconnection circuit 104 includes a plurality of multiplexers 402, 404, a plurality of D-type flip-flops (DFFs) 406, 408, a NAND gate 410, and an inverter 412. The DFFs 406 and 408 are triggered by clock signals CK₁ and CK₂, respectively. In this embodiment, the clock signals CK₁ and CK₂ may be derived from the same clock source. The multiplexer 402 has a first input node N11, a second input node N12 and an output node N13. The multiplexer 404 has a first input node N21, a second input node N22 and an output node N23. Each of the multiplexers 402 and 404 can be controlled by a mode selection signal MODE. For example, when an average critical path monitor (CPM) is desired by an AVS application, the multiplexer 402 is capable of coupling the output node N13 to the first input node N11 in response to the mode selection signal MODE, and the multiplexer 404 is capable of coupling the output node N23 to the first input node N21 in response to the mode selection signal MODE. In this speed information detection mode (average mode), the CPE 102 is coupled to an average frequency meter 430. Specifically, the combination of the CPE 102, the NAND gate 410 and the average frequency meter 430 can act as the average CPM. As can be readily seen from FIG. 4, the output port P2 of the CPE 102 can be coupled to the input port P1 of the CPE 102 via the interconnection circuit 104 having the first interconnection arrangement. Besides, a logic value “1” may be fed into one input of the NAND gate 410 to make the NAND gate 410 act as an inverter. Hence, the CPE 102 can operate like a ring oscillator (ROSC), where an output signal S_OUT generated from the output port P2 of the CPE 102 can be transmitted to the average frequency meter 430. By way of example, the average frequency meter 430 may include a ripple counter and a frequency meter, where the frequency meter may be driven by a reference clock with a fixed clock rate (e.g., 26 MHz) to measure the ROSC speed by counting cycles of the CPE output in a frequency meter window. To put it simply, the average frequency meter 430 can perform wide-range detection with longer detection time, and is capable of detecting low-frequency variation, such as process and/or temperature variation. Thus, the average frequency meter 430 can provide “coarse” max speed information. It should be noted that any circuit structure capable of performing the low-frequency variation detection may be employed to realize the average frequency meter 430. As the present invention focuses on the hybrid architecture of the critical path emulating apparatus, further description of the average frequency meter 430 is omitted here for brevity.

However, when a sampling CPM is desired by the AVS application, the multiplexer 402 is capable of coupling the output node N13 to the second input node N12 in response to the mode selection signal MODE, and the multiplexer 404 is capable of coupling the output node N23 to the second input node N22 in response to the mode selection signal MODE. In this speed information detection mode (sampling mode), the CPE 102 is coupled to a clock-to-clock margin detector 420. Specifically, the combination of the CPE 102, the DFFs 406 and 408, the inverter 412 and the clock-to-clock margin detector 420 can act as the sampling CPM. As can be readily seen from FIG. 4, the DFF 408 and the inverter 412 can operate as a frequency divider, and can generate a reference clock CK₃ to the input port P1 of the CPE 102 through the interconnection circuit 104 having the second interconnection arrangement. Besides, the output signal S_OUT generated from the output port P2 of the CPE 102 can be transmitted to the clock-to-clock margin detector 420, where the clock-to-clock margin detector 420 is capable of measuring a clock-to-clock margin based on the CPE output and the clock signal CK₁. The clock-to-clock margin detector 420 is capable of performing the timing margin detection on the clock cycle basis, thus requiring short detection time. Specifically, the clock-to-clock margin detector 420 is capable of detecting high-frequency variation, such as clock jitter, dynamic IR, etc. Therefore, the clock-to-clock margin detector 420 is capable of providing “fine” max speed information. It should be noted that any circuit structure capable of performing the high-frequency variation detection may be employed to realize the clock-to-clock margin detector 420. As the present invention focuses on the hybrid architecture of the critical path emulating apparatus, further description of the clock-to-clock margin detector 420 is omitted here for brevity.

It should be noted that the speed information of the same critical path obtained by one or both of the clock-to-clock margin detector 420 and the average frequency meter 430 may be used for speed binning (i.e., the critical path emulating apparatus is employed for a speed binning application), power saving (i.e., the proposed critical path emulating apparatus is employed for a power saving application) or other purpose, depending upon actual application requirement.

In addition, based on an operational scenario (e.g., movie viewing, webpage viewing, sleep mode, etc.) of the target device (e.g., a processor or one core of a multi-core processor), the CPE 102 can be adaptively configured to employ one of the first CPE element 112 and the second CPE element 114, and/or the interconnection circuit 104 can be adaptively configured to employ one of the first interconnection arrangement 122 and the second interconnection arrangement 124. For example, when the target device is operated under a first operational scenario, a sampling CPM having the CDE selected as the CPE can be employed to generate a margin index for power management; when the target device is operated under a second operational scenario, a sampling CPM having the CPC circuit selected as the CPE can be employed to generate a margin index for power management; when the target device is operated under a third operational scenario, an average CPM having the CDE selected as the CPE can be employed to generate a margin index for power management; and when the target device is operated under a fourth operational scenario, an average CPM having the CPC circuit selected as the CPE can be employed to generate a margin index for power management. In this way, the CPM mismatch error can be efficiently reduced by properly configuring the critical path emulating apparatus 100 in response to the current operational scenario of the target device. The objective of adjusting the supply voltage of the target device as low as possible and also maintaining the desired system stability and performance of the target device can be achieved. It should be noted that the above is for illustrative purposes only, and is not meant to be a limitation of the present invention. In practice, any application employing the proposed hybrid architecture shown in FIG. 1 falls within the scope of the present invention. For example, the switching between CDE and CPC and/or the switching between sampling mode and average mode may be set dynamically or fixedly. These alternative designs all fall within the scope of the present invention.

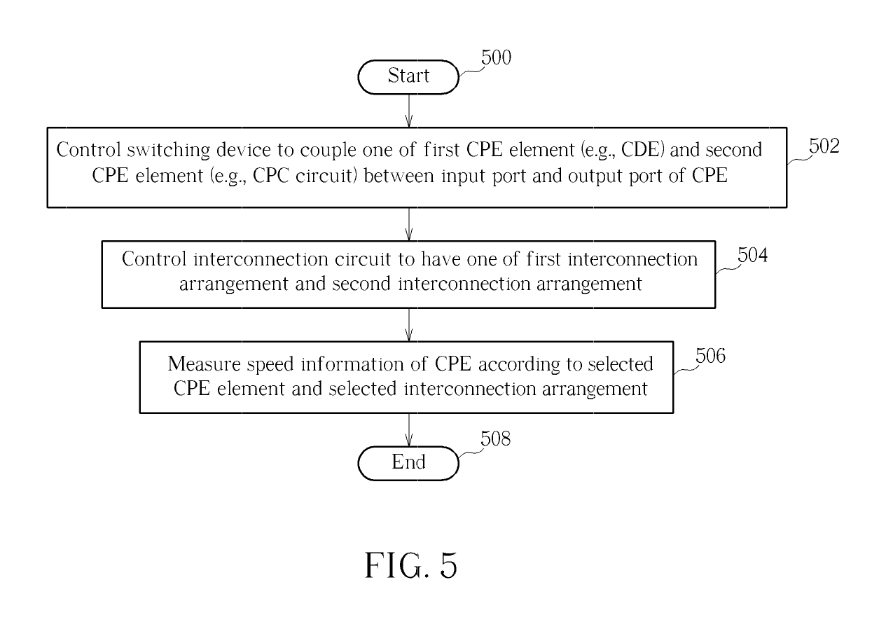

FIG. 5 is a flowchart illustrating a control method of the critical path emulating apparatus 100 shown in FIG. 1. The control method of the critical path emulating apparatus 100 may be briefly summarized as below.

Step 500: Start.

Step 502: Control the switching device 116 to couple one of the first CPE element (e.g., a CDE) 112 and the second CPE element (e.g., a CPC circuit) 114 between the input port P1 and the output port P2 of the CPE 102.

Step 504: Control the interconnection circuit 104 to have one of the first interconnection arrangement (e.g., an interconnection capable of enabling an average mode) and the second interconnection arrangement (e.g., an interconnection capable of enabling a sampling mode), where the CPE 102 is capable of being used in a first speed information detection mode (e.g., the average mode) when the first interconnection arrangement is selected, and capable of being used in a second speed information detection mode (e.g., the sampling mode) when the second interconnection arrangement is selected.

Step 506: Measure speed information of the CPE 102 according to the selected CPE element and the selected interconnection arrangement.

Step 508: End.

Please note that if the result is substantially the same, the steps are not required to be executed in the exact order shown in FIG. 5. For example, step 504 may be executed before step 502 is executed, or steps 502 and 504 may be executed simultaneously. Step 502 enables a hybrid critical path emulator to switch between a plurality of CPE elements, and step 504 enables a hybrid interconnection circuit to configure the CPE to switch between a plurality of speed information detection modes. As a person skilled in the art can readily understand details of the steps shown in FIG. 5 after reading above paragraphs, further description is omitted here for brevity.

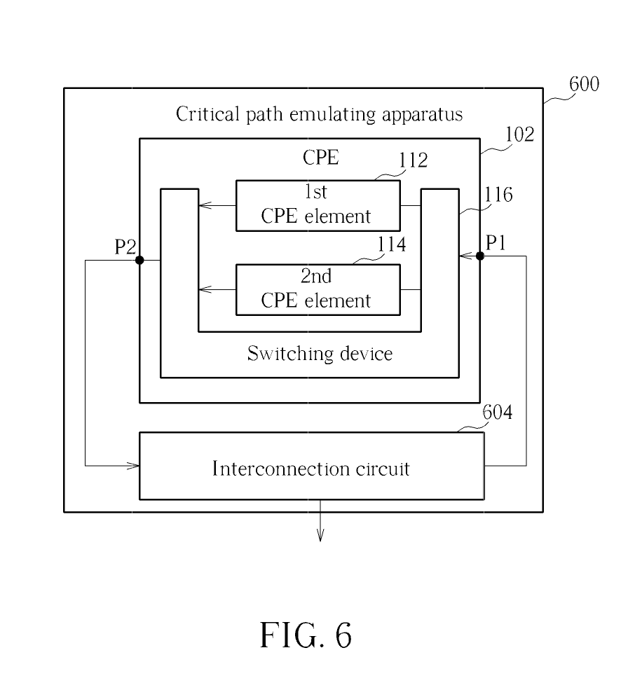

In above embodiment, each of the CPE 102 and the interconnection circuit 104 employs hybrid architecture. However, the spirit of the present invention is obeyed as long as hybrid architecture is employed in at least one of the CPE 102 and the interconnection circuit 104. FIG. 6 is a block diagram illustrating a generalized critical path emulating apparatus according to another embodiment of the present invention. The major difference between the critical path emulating apparatuses 100 and 600 is the design of the interconnection circuit. Specifically, regarding the interconnection circuit 604 of the critical path emulating apparatus 600, it has a single interconnection arrangement. That is, the interconnection circuit 604 employs a fixed interconnection arrangement. In one exemplary design, the interconnection circuit 604 has the first interconnection arrangement 122. Hence, no matter which one of the first CPE element 112 and the second CPE element 114 is selected by the switching device 116, the CPE 102 is allowed to be used under the first speed information detection mode (e.g., the average mode) such that the output signal generated from the output port P2 of the CPE 102 is fixedly transmitted to one speed meter (e.g., the average frequency meter 430). In another exemplary design, the interconnection circuit 604 has the second interconnection arrangement 124. Hence, no matter which one of the first CPE element 112 and the second CPE element 114 is selected by the switching device 116, the CPE 102 is allowed to be used under the second speed information detection mode (e.g., the sampling mode) such that the output signal generated from the output port P2 of the CPE 102 is fixedly transmitted to another speed meter (e.g., the clock-to-clock margin detector 420).

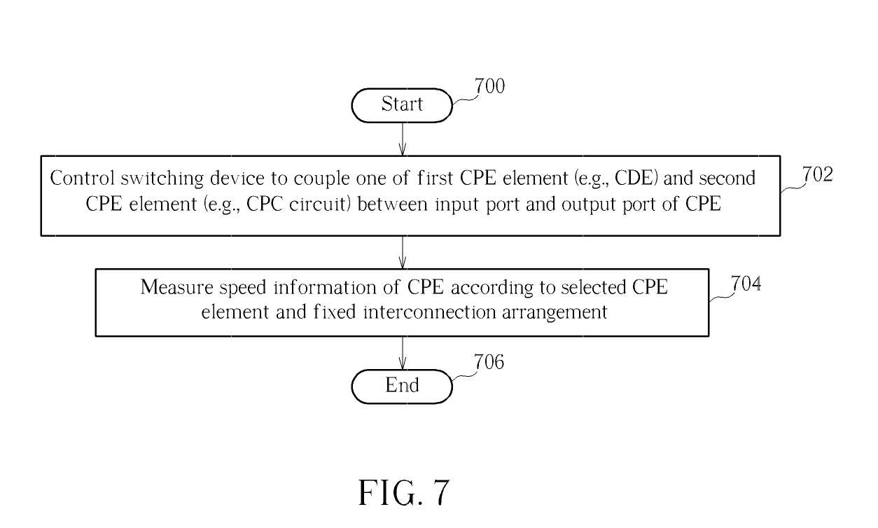

FIG. 7 is a flowchart illustrating a control method of the critical path emulating apparatus 600 shown in FIG. 6. Please note that if the result is substantially the same, the steps are not required to be executed in the exact order shown in FIG. 7. The control method of the critical path emulating apparatus 600 may be briefly summarized as below.

Step 700: Start.

Step 702: Control the switching device 116 to couple one of the first CPE element (e.g., a CDE) 112 and the second CPE element (e.g., a CPC circuit) 114 between the input port P1 and the output port P2 of the CPE 102.

Step 704: Measure speed information of the CPE 102 according to the selected CPE element and the fixed interconnection arrangement of the interconnection circuit 604.

Step 706: End.

As a person skilled in the art can readily understand details of the steps shown in FIG. 7 after reading above paragraphs, further description is omitted here for brevity.

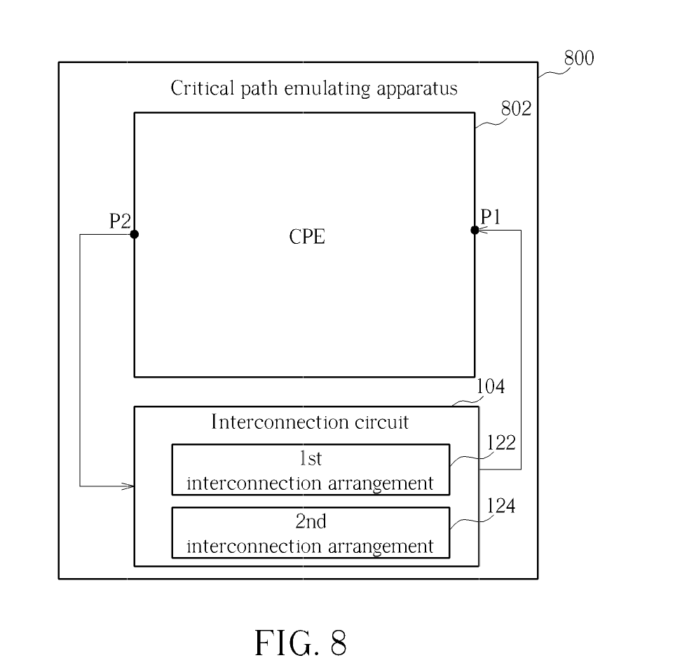

FIG. 8 is a block diagram illustrating a generalized critical path emulating apparatus according to yet another embodiment of the present invention. The major difference between the critical path emulating apparatuses 100 and 800 is the design of the critical path emulator. Specifically, regarding the CPE 802 of the critical path emulating apparatus 800, it has a single CPE element. That is, the critical path emulating apparatus 800 employs a fixed CPE design. In one exemplary design, the CPE 802 may have the first CPE element 112. Hence, no matter which one of the first interconnection arrangement 122 and the second interconnection arrangement 124 is employed by the interconnection circuit 104, the CPE 802 with a fixed circuit structure (e.g., the CDE 200) is used. In one exemplary design, the CPE 804 may have the second CPE element 112. Hence, no matter which one of the first interconnection arrangement 122 and the second interconnection arrangement 124 is employed by the interconnection circuit 104, the CPE 802 with a fixed circuit structure (e.g., the CPC circuit 300) is used.

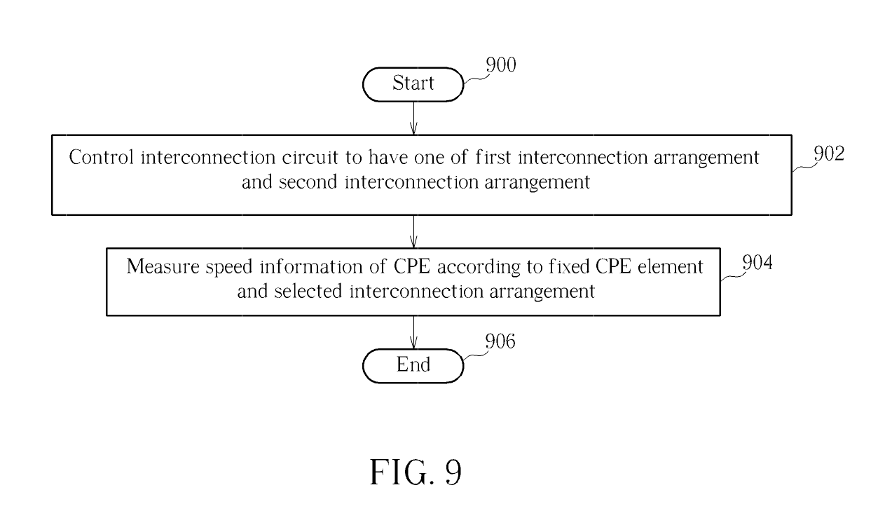

FIG. 9 is a flowchart illustrating a control method of the critical path emulating apparatus 800 shown in FIG. 8. Please note that if the result is substantially the same, the steps are not required to be executed in the exact order shown in FIG. 9. The control method of the critical path emulating apparatus 800 may be briefly summarized as below.

Step 900: Start.

Step 902: Control the interconnection circuit 104 to have one of the first interconnection arrangement (e.g., an interconnection capable of enabling an average mode) and the second interconnection arrangement (e.g., an interconnection capable of enabling a sampling mode), where the CPE 102 is capable of being used in a first speed information detection mode (e.g., the average mode) when the first interconnection arrangement is selected, and capable of being used in a second speed information detection mode (e.g., the sampling mode) when the second interconnection arrangement is selected.

Step 904: Measure speed information of the CPE 802 according to the fixed CPE element of the CPE 802 and the selected interconnection arrangement.

Step 908: End.

As a person skilled in the art can readily understand details of the steps shown in FIG. 9 after reading above paragraphs, further description is omitted here for brevity.

It should be noted that an actual circuit design may have more than one critical path, and the critical path(s) may change with the operating voltage(s). In a first case where the target device has N operating voltages, N hybrid critical path emulators, each being capable of switching between CDE and CPC, may be employed for emulating N critical paths corresponding to the N operating voltages, respectively. Besides, each of the N hybrid critical path emulators is capable of being used in a speed information detection mode selected from the sampling mode and the average mode.

In a second case where the target device has N operating voltages, N hybrid critical path emulators, each being capable of switching between CDE and CPC, may be employed for emulating N critical paths corresponding to the N operating voltages, respectively. Based on different operating voltages and/or different characteristics of the critical paths, some of the N hybrid critical path emulators are used in the average mode fixedly, and the rest of the N hybrid critical path emulators are used in the sampling mode fixedly.

In a third case where the target device has N operating voltages, N critical path emulators, including some path emulators fixedly being configurable delay emulators and remaining path emulators fixedly being critical path cloning circuits, may be employed for emulating N critical paths corresponding to the N operating voltages, respectively. Besides, each of the N critical path emulators is capable of being used in a speed information detection mode selected from the sampling mode and the average mode.

In a fourth case where the target device has N operating voltages, N critical path emulators may be employed for emulating N critical paths corresponding to the N operating voltages, respectively. However, based on different operating voltages and/or different characteristics of the critical paths, each of the N path emulators is fixedly configured as a configurable delay emulator or a critical path cloning circuit, and is fixedly used in the average mode or the sampling mode.

Generally speaking, critical path cloning circuit is capable of emulating the actual critical path more accurately. However, if the model has errors, the performance of the critical path emulation based on critical path cloning circuit would be significantly degraded. In contract to the critical path cloning, the configurable delay emulator is more flexible. However, the configurable delay emulator may not emulate the actual critical path as accurately as critical path cloning circuit does.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A critical path emulating apparatus, comprising:
a critical path emulator (CPE), capable of emulating a critical path of a target device, and capable of supporting a plurality of speed information detection modes; and
an interconnection circuit, capable of supporting a plurality of interconnection arrangements, wherein when the interconnection circuit is configured to have a first interconnection arrangement, the CPE is capable of being used in a first speed information detection mode, and when the interconnection circuit is configured to have a second interconnection arrangement, the CPE is capable of being used in a second speed information detection mode.

2. The critical path emulating apparatus of claim 1, wherein the CPE is a configurable delay emulator (CDE) having a plurality of cells, and a cell selection of the CDE is based on the critical path.

3. The critical path emulating apparatus of claim 1, wherein the CPE is a critical path cloning (CPC) circuit, which clones the critical path.

4. The critical path emulating apparatus of claim 1, wherein the CPE comprises:
a first CPE element, capable of emulating the critical path;
a second CPE element, capable of emulating the critical path, wherein the first CPE element and the second CPE element have different circuit structures; and
a switching device, capable of selecting and coupling one of the first CPE element and the second CPE element between an input port and an output port of the CPE.

5. The critical path emulating apparatus of claim 4, wherein the first CPE element is a configurable delay emulator (CDE) having a plurality of cells, where a cell selection of the CDE is based on the critical path; and the second CPE element is a critical path cloning (CPC) circuit, which clones the critical path.

6. The critical path emulating apparatus of claim 1, wherein when the interconnection circuit has the first interconnection arrangement, an output port of the CPE is coupled to the input port of the CPE via the interconnection circuit.

7. The critical path emulating apparatus of claim 1, wherein when the interconnection circuit has the first interconnection arrangement, an output signal generated from an output port of the CPE is transmitted to an average frequency meter via the interconnection circuit.

8. The critical path emulating apparatus of claim 1, wherein when the interconnection circuit has the second interconnection arrangement, a reference clock is fed into an input port of the CPE via the interconnection circuit.

9. The critical path emulating apparatus of claim 1, wherein when the interconnection circuit has the second interconnection arrangement, an output signal generated from an output port of the CPE is transmitted to a clock-to-clock margin detector via the interconnection circuit.

10. The critical path emulating apparatus of claim 1, wherein the critical path emulating apparatus is employed for a speed binning application.

11. The critical path emulating apparatus of claim 1, wherein the critical path emulating apparatus is employed for a power saving application.

12. A critical path emulating apparatus, comprising:
a critical path emulator (CPE), capable of emulating a critical path of a target device, comprising:
a first CPE element, capable of emulating the critical path;
a second CPE element, capable of emulating the critical path, wherein the first CPE element and the second CPE element have different circuit structures; and
a switching device, capable of selecting and coupling one of the first CPE element and the second CPE element between an input port and an output port of the CPE; and
an interconnection circuit, capable of enabling the CPE to be capable of being used in a predetermined speed information detection mode.

13. The critical path emulating apparatus of claim 12, wherein the first CPE element is a configurable delay emulator (CDE) having a plurality of cells, and a cell selection of the CDE is based on the critical path.

14. The critical path emulating apparatus of claim 12, wherein the second CPE element is a critical path cloning (CPC) circuit, which clones the critical path.

15. The critical path emulating apparatus of claim 12, wherein the output port of the CPE is coupled to the input port of the CPE via the interconnection circuit.

16. The critical path emulating apparatus of claim 12, wherein an output signal generated from the output port of the CPE is transmitted to an average frequency meter via the interconnection circuit.

17. The critical path emulating apparatus of claim 12, wherein a reference clock is fed into the input port of the CPE via the interconnection circuit.

18. The critical path emulating apparatus of claim 12, wherein an output signal generated from the output port of the CPE is transmitted to a clock-to-clock margin detector via the interconnection circuit.

19. The critical path emulating apparatus of claim 12, wherein the critical path emulating apparatus is employed for a speed binning application.

20. The critical path emulating apparatus of claim 12, wherein the critical path emulating apparatus is employed for a power saving application.
